(19) United States
(12) Patent Application Publication
(10) Pub. No.: US 2026/0001747 A1
(43) Pub. Date: Jan. 1, 2026

(54) CRANE AND CRANE ASSEMBLY METHOD

(71) Applicant: KOBELCO CONSTRUCTION MACHINERY CO., LTD., Hiroshima-shi (JP)

(72) Inventors: Koji SUMIMOTO, Hyogo (JP); Teppei MAEDO, Hyogo (JP)

(73) Assignee: KOBELCO CONSTRUCTION MACHINERY CO., LTD., Hiroshima-shi (JP)

(21) Appl. No.: 18/881,524

(22) PCT Filed: Jul. 6, 2023
(86) PCT No.: PCT/JP2023/025122

§ 371 Date: Jan. 6, 2025

(30) Foreign Application Priority Data
Jul. 21, 2022 (JP) 2022-116102

(51) Int. Cl. B66C 23/36; B66C 23/82

(52) U.S. Cl. CPC B66C 23/36; B66C 23/823; B66C 2700/0371

(57) ABSTRACT

Provided are a crane enabling workability to be improved about connecting a guyline for interconnecting a strut and a boom to the boom, and a crane assembly method. A rope tip part of a winch rope is connected to an intermediate member in a state where a boom and a jib have been fallen on the ground. A winch performs a winding motion of winding the winch rope, thereby raising a strut and making the intermediate member approach a guyline connection part of the boom to allow a boom connection end part of a second guyline that is connected to the intermediate member to be connected to the guyline connection part.

### TECHNICAL FIELD

The present invention relates to a crane and a method for assembling a crane.

### BACKGROUND ART

Patent Literature 1 discloses a method for assembling a crane. The method includes connecting a main hoisting rope, which is a winch rope, to a suspension lug of a jib mast (a strut in the literature), and towing the suspension lug by winding the main hoisting rope by a winch mounted on the machine body to thereby raise the strut from a fallen posture.

The method requires work of connecting a strut guyline for interconnecting the raised strut and a predetermined connection position in a boom to a predetermined position in the boom. In the work, there may be no margin in the length of the strut guyline, depending on the offset angle of the jib or the configuration of the crane itself, which involves a necessity for a worker to connect the strut guyline to the connection position of the boom while pulling the strut guyline. It would not be easy to handle the strut guyline, which is heavy, for such work, on a boom at a high place with poor foothold.

### CITATION LIST

### Patent Literature

Patent Literature 1: Japanese Unexamined Patent Publication No. 2011-190084

### SUMMARY OF INVENTION

It is an object of the present invention to provide a crane and a crane assembly method which enable the workability to be improved on connecting a guyline for interconnecting a strut and a boom to a predetermined position in the boom.

Provided is a crane comprising a crane body, a boom, a jib, a strut, a winch, a winch rope, an intermediate member, at least one first guyline, and at least one second guyline. The boom includes a boom proximal end part connected to the crane body so as to allow the boom to be raised and lowered with respect to the crane body, a boom distal end part on the side opposite to the boom proximal end part, and a guyline connection part. The jib includes a jib proximal end part connected to the boom distal end part so as to allow the jib to be raised and lowered with respect to the boom. The strut includes a strut proximal end part and a guyline connection part, and the strut proximal end part is connected to the boom distal end part or the jib proximal end part capably of vertically rotational movement so as to allow the strut to be raised and lowered with respect to the jib. The winch is fixed to the crane body or the boom, and performs a winding motion and a delivery motion. The winch rope is wound to the winch by the winding motion and delivered from the winch by the delivery motion. The winch rope includes a rope tip part that is moved, in a direction to approach the winch, by the winding motion. The intermediate member is connectable to the rope tip part so as to be moved by the winding motion together with the rope tip part. The at least one first guyline is disposed to interconnect the strut and the intermediate member, including a strut connection end part to be connected to the strut and a first intermediate connection end part, which is an end part on the side opposite to the strut connection end part, to be connected to the intermediate member. The at least one second guyline is disposed to interconnect the intermediate member and the boom, including a boom connection end part to be connected to the guyline connection part of the boom and a second intermediate connection end part, which is an end part on the side opposite to the boom connection end part, to be connected to the intermediate member. The at least one first guyline interconnects the strut and the intermediate member so as to allow the strut having been fallen onto the ground to be raised by the winch performing the winding motion of winding the winch rope with the rope tip part connected to the intermediate member in a boom-and-jib fallen state where the boom and the jib have been fallen onto the ground. The second intermediate connection end part of the at least one second guyline is connected to the intermediate member so as to allow the at least one second guyline to be made approach the guyline connection part together with the intermediate member by the winding motion of the winch to allow the boom connection end part of the second guyline to be connected to the guyline connection part.

Also provided is a method for assembling a crane. The crane includes a boom, a jib, a strut, a winch rope, an intermediate member, a first guyline, and a second guyline. The boom includes a boom proximal end part connected to the crane body so as to allow the boom to be raised and lowered with respect to the crane body, a boom distal end part on the side opposite to the boom proximal end part, and a guyline connection part. The jib includes a jib proximal end part connected to the boom distal end part so as to allow the jib to be raised and lowered with respect to the boom. The strut includes a strut proximal end part and a guyline connection part, and the strut proximal end part is connected to the boom distal end part or the jib proximal end part capably of vertically rotational movement so as to allow the strut to be raised and lowered with respect to the jib. The winch is fixed to the crane body or the boom, and performs a winding motion and a delivery motion. The winch rope is wound to the winch by the winding motion and delivered from the winch by the delivery motion. The winch rope includes a rope tip part that is moved, in a direction to approach the winch, by the winding motion. The intermediate member is connectable to the rope tip part so as to be moved by the winding motion together with the rope tip part. The first guyline is disposed to interconnect the strut and the intermediate member, including a strut connection end part to be connected to the strut and a first intermediate connection end part, which is an end part on the side opposite to the strut connection end part, to be connected to the intermediate member. The second guyline is disposed to interconnect the intermediate member and the boom, including a boom connection end part to be connected to the guyline connection part of the boom and a second intermediate connection end part, which is an end part on the side opposite to the boom connection end part, to be connected to the intermediate member. The method includes: connecting the rope tip part to the intermediate member and making the winch perform the winding motion in a boom-and-jib fallen state where the boom and jib have been fallen onto the ground to thereby raise the strut having been fallen on the jib; and making the winch perform the winding motion in a state where the second intermediate connection end part of the second guyline is connected to the intermediate member to thereby make the intermediate member and the second guyline approach the guyline connection part and connecting the boom connection end part of the second guyline to the guyline connection part.

### BRIEF DESCRIPTION OF DRAWINGS

FIG. 1 is a side view of a crane according to the disclosed embodiment, showing a state where a boom has been raised.

FIG. 2 is a side view of the crane, showing a boom-and-jib fallen state where the boom and jib connected thereto have been fallen onto the ground.

FIG. 3 is a view where the part enclosed by the enclosing line III in FIG. 2 is enlarged.

FIG. 4 is a plan view schematically showing the part shown in FIG. 3.

FIG. 5 is a plan view of an intermediate member of the crane and the periphery thereof.

FIG. 6 is a plan view of the intermediate member, which includes a pair of first outer parts.

FIG. 7 is a plan view of the intermediate member, which includes a pair of second outer parts longer than the pair of first outer parts.

FIG. 8 is a view where the part enclosed by the enclosing line VIII in FIG. 5 is enclosed.

FIG. 9 is a view where the part enclosed by the enclosing line IX in FIG. 6 is enclosed.

FIG. 10 is a view showing the cross section along the X-X line in FIG. 9.

FIG. 11 is a side view of a crane including a boom longer than that of the crane shown in FIG. 2, the crane being in a boom-and-jib fallen state.

### DESCRIPTION OF EMBODIMENTS

Hereinafter will be described a preferred embodiment of the present invention with reference to the drawings.

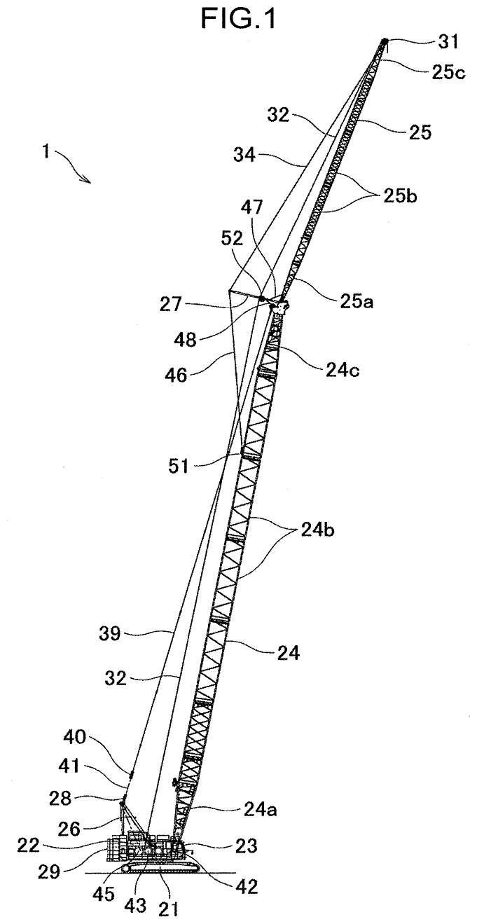

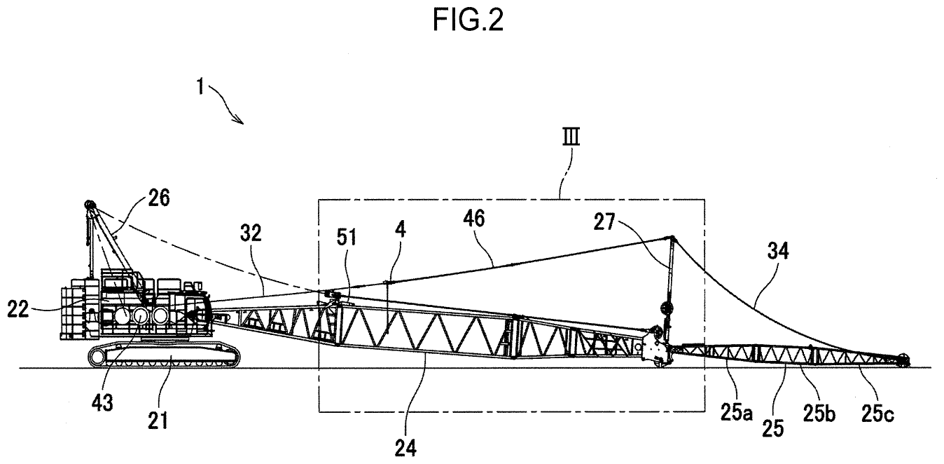

FIGS. 1 and 2 show a crane 1 according to the embodiment. The crane 1 includes a crane body, which includes a lower traveling body 21 and an upper turning body 22 mounted on the lower traveling body 21 capably of turning. The lower traveling body 21 includes a lower frame and a traveling means, which includes a pair of crawlers. The crane 1 may be either a mobile crane including a moving means different from the pair of crawlers, such as a plurality of wheels, or a fixed crane with no traveling means.

The upper turning body 22 includes a turning frame 22a, an operation chamber 23, and a counterweight 29. The turning frame 22a is a base substantially parallel to the traveling surface of the lower traveling body 21, connected to the lower frame of the lower traveling body 21 capably of turning. The operation chamber 23 and the counterweight 29 are mounted on the front and rear parts of the turning frame 22a, respectively.

The crane 1 further includes a plurality of elements supported by the turning frame 22a, the plurality of elements including a boom 24, a jib 25, a gantry 26, a strut 27, a lower spreader 28, a hoisting rope 32, an upper spreader 40, a boom derricking rope 41, a hoisting winch 43, a boom derricking winch 45, a jib backstop device 47, and a strut backstop device 48.

The boom 24 is connected (attached) to the front part of the turning frame 22a of the upper turning body 22 capably of being raised and lowered with respect to the upper turning body 22. Specifically, as shown in FIG. 1, the boom 24 includes a lower boom 24a, at least one intermediate boom 24b, and an upper boom 24c, and FIG. 1 shows a state where the boom 24 has been raised. The lower boom 24a includes a proximal end part and a distal end part on the side opposite thereto. The proximal end part forms a boom proximal end part connected to the turning frame 22a capably of vertically rotational movement. The at least one intermediate boom 24b is interposed between the lower boom 24a and the upper boom 24c so as to interconnect the distal end part of the lower boom 24a and the upper boom 24c. The upper boom 24c includes a distal end part that is an end part opposite to the lower boom 24a and the at least one intermediate boom 24b, the distal end part forming a boom distal end part. The boom distal end part is the end part on the side opposite to the boom proximal end part out of the opposite end parts of the boom 24. To the boom distal end part is connectable one end of a boom guyline 39.

The jib 25 includes a jib proximal end part and a jib distal end part on the side opposite to the jib proximal end part. The jib proximal end part is connected (attached) to the boom distal end part of the boom 24, i.e., the distal end part of the upper boom 24c in the present embodiment, so as to allow the jib 25 to be raised and lowered with respect to the boom 24. The jib 25 illustrated in FIG. 1 includes a lower jib 25a, at least one intermediate jib 25b, and an upper jib 25c. The lower jib 25a includes a proximal end part and a distal end part on the side opposite thereto, the proximal end part forming the jib proximal end part to be connected to the boom distal end part capably of vertically rotational movement. The at least one intermediate jib 25b is interposed between the distal end part of the lower jib 25a and the upper jib 25c so as to interconnect the distal end part of the lower jib 25a and the upper jib 25c. The upper jib 25c includes a distal end part that is the end part opposite to the lower jib 25a and the at least one intermediate jib 25b, the distal end part forming a jib distal end part. The jib distal end part is the end part on the side opposite to the jib proximal end part out of the opposite end parts of the jib 25. To the jib distal end part of the jib 25 is rotatably attached a jib point sheave 31, from which a non-illustrated hook device is suspended through the hoisting rope 32.

The gantry 26 is fixed to the rear part of the turning frame 22a to support the boom distal end part of the boom 24. The crane according to the present invention, alternatively, may include a mast in place of the gantry 26.

The strut 27 includes a strut proximal end part and a strut distal end part on the side opposite to the strut proximal end part, and the strut proximal end part is connected (attached) to the jib proximal end part of the jib 25 (the proximal end part of the lower jib 25a in the present embodiment) capably of vertically rotational movement around a predetermined strut rotation center so as to allow the strut 27 to be raised and lowered with respect to the jib 25. The strut proximal end part of the strut 27, alternatively, may be connected to the boom distal end part of the boom 24 (the distal end part of the upper boom 24c in the present embodiment) capably of vertically rotational movement.

The strut distal end part of the strut 27 and the jib distal ond part of the jib 25 are interconnected through a jib guyline 34. Besides, the strut distal end part of the strut 27 and a pair of guyline connection parts 51 included in the boom 24 are interconnected through a pair of strut guyline sets 46, respectively. Each of the strut guyline sets 46 includes opposite end parts, one of the opposite end parts being a boom connection end part to be detachably connected to each of the guyline connection parts 51, the other being a strut connection end part.

To a center part of the strut 27 is rotatably attached a sheave 52, on which the hoisting rope 32 is placed.

The lower spreader 28 and the upper spreader 40 constitute a boom derricking device in association with the boom derricking rope 41 and the boom derricking winch 45. The lower spreader 28 is attached to the upper end of the gantry 26, and the upper spreader 40 is connected to the spreader connection end part of the boom guyline 39. The boom derricking rope 41 is stretched between the lower spreader 28 and the upper spreader 40.

The hoisting winch 43 and the boom derricking winch 45 are fixed to a center part of the turning frame 22a. The hoisting winch 43 includes a hoisting winch drum, around which the hoisting rope 32 is wound. The hoisting winch 43 is an example of a winch according to the present invention, and the hoisting rope 32 is an example of a winch rope according to the present invention, the hoisting rope 32 including a rope tip part to be connected to the strut 27 as described later. The boom derricking winch 45 includes a boom derricking winch drum, around which the boom derricking rope 41 is wound. The hoisting winch 43, alternatively, may be fixed to the boom proximal end part of the boom 24 or the vicinity thereof (the lower boom 24a in the present embodiment). Besides, the boom derricking winch 45 may be fixed to a lower part of the gantry 26.

The hoisting winch 43 is capable of performing a winding motion of winding the hoisting rope 32 and a delivery motion of delivering the hoisting rope 32 through respective rotations of the hoisting winch drum in opposite directions, the winding motion and the delivery motion moving the rope tip part of the hoisting rope 32 in the longitudinal direction of the hoisting rope 32, thereby performing the hoisting and lowering of the hook device, respectively. The boom derricking winch 45 is capable of performing a winding motion of winding the boom derricking rope 41 and a delivery motion of delivering the boom derricking rope 41 through respective rotations of the boom derricking winch drum in opposite directions, the winding motion and the delivery motion raising and lowering the boom 24, respectively. Specifically, the boom 24 is brought into vertically rotational movement around a horizontal boom foot pin 42 which is the fulcrum of the boom 24.

The jib backstop device 47 is provided on a lower part in the jib back surface of the jib 25. The jib backstop device 47 comes to be received by a non-illustrated backstop receiver provided in the strut 27 accompanying the rotational movement of the jib 25 in the direction in which the jib 25 is raised, that is, moved toward the strut 27, with respect to the boom 24, thereby preventing the jib 25 from excessive rotational movement in the raised direction.

The strut backstop device 48 is provided in a lower part of a strut back surface of the strut 27. The strut back surface is a surface on the side opposite to the strut front surface, that is, a surface facing the opposite side to the jib 25. The strut backstop device 48 comes to be received by a non-illustrated backstop receiver provided in the boom 24 accompanying the rotational movement of the strut 27 with respect to the boom 24 and the jib 25 in the direction in which the strut 27 is raised, that is, moved toward the boom 24, thereby preventing the strut 27 from excessive rotational movement in the raised direction.

The disassembly and assembly of the thus configured crane 1 are performed in a boom-and-jib fallen state where both the boom 24 and the jib 25 have been fallen onto the ground as shown in FIG. 2. The state of the crane 1 shown in FIG. 2 differs from the state of the crane 1 shown in FIG. 1 in that the overall length of the derricking member including the boom 24a the jib 25 is small, but this point is not directly affected by the following description.

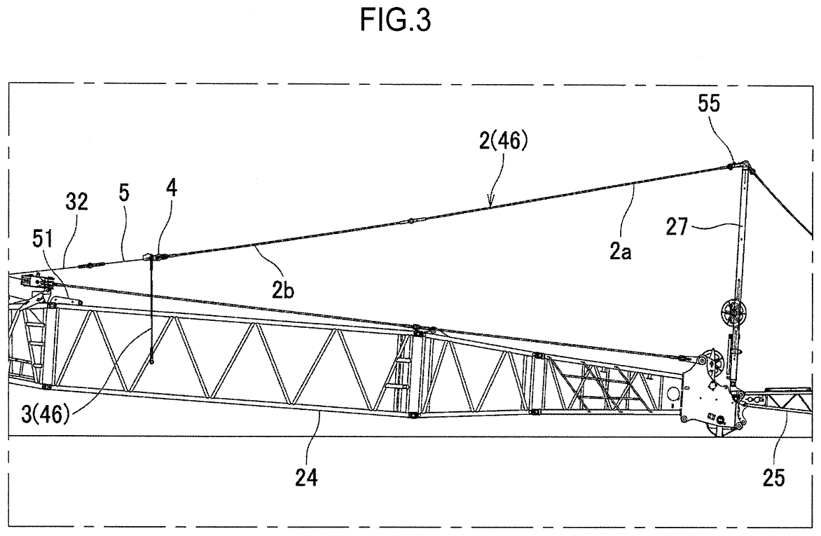

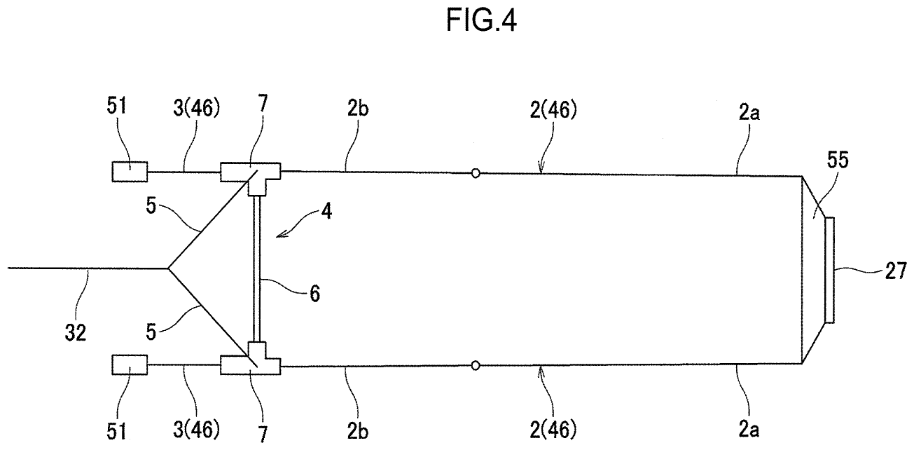

FIG. 3 is a view in which the part enclosed by the enclosing line III shown in FIG. 2 is enlarged, and FIG. 4 is a plan view of the part shown in FIG. 3. As shown in FIGS. 3 and 4, each of the strut guyline sets 46 includes a first guyline 2 and a second guyline 3. In other words, the crane 1 includes a pair of first guylines 2 and a pair of second guylines 3. In each of the strut guyline sets 46, the first guyline 2 and the second guyline 3 are aligned in series in the longitudinal directions thereof. The first guyline 2 is an element to be connected to the pair of guyline connection parts 51 of the boom 24, and the second guyline 3 is an element to be connected to the strut distal end part of the strut 27.

On the other hand, the strut 27 includes, in addition to a strut body with the strut proximal end part and the strut distal end, a guyline connection member 55 and a rope connection member 56 shown in FIG. 3. The guyline connection member 55 is interposed between the strut distal end part and the pair of strut guyline sets 46. Specifically, in a boom width direction, which is the width direction of the boom 24 (vertical direction in FIG. 4), the guyline connection member 55 includes an intermediate part connected to the strut distal end part and opposite end parts located on opposite outer sides of the intermediate part, to which end parts respective strut connection end parts of the pair of strut guyline sets 46 are connected, respectively. The strut connection end parts are respective end parts of the first guylines 2 of the pair of strut guyline sets 46, being the end parts on the side opposite to the second guyline 3.

The crane 1 further includes an intermediate member 4, which is interposed between the first guyline 2 and the second guyline 3 in each of the strut guyline sets 46. The first guyline 2 is disposed to interconnect the strut 27 (the guyline connection member 55 in the present embodiment) and the intermediate member 4. Specifically, each of the first guylines 2 includes opposite end parts, one of which is a guyline connection part end to be connected to the guyline connection member 55 of the strut 27 and the other is a first intermediate connection end part to be connected to the intermediate member 4. More specifically, the intermediate member 4 has a shape extending in the boom width direction, and respective first intermediate connection end parts of the first guylines 2 of the pair of strut guyline sets 46, that is, the pair of first guylines 2, are connected to the opposite end parts of the intermediate member 4, respectively.

To the opposite end parts of the intermediate member 4 are connected respective end parts of the pair of second guylines 3, respectively, in addition to the pair of first guylines 2. Specifically, each of the second guylines 3 includes opposite end parts, one of which is a second intermediate connection end part to be connected to each of the opposite end parts of the intermediate member 4 and the other is a boom connection end part to be connected to each of the guyline connection parts 51 of the boom 24.

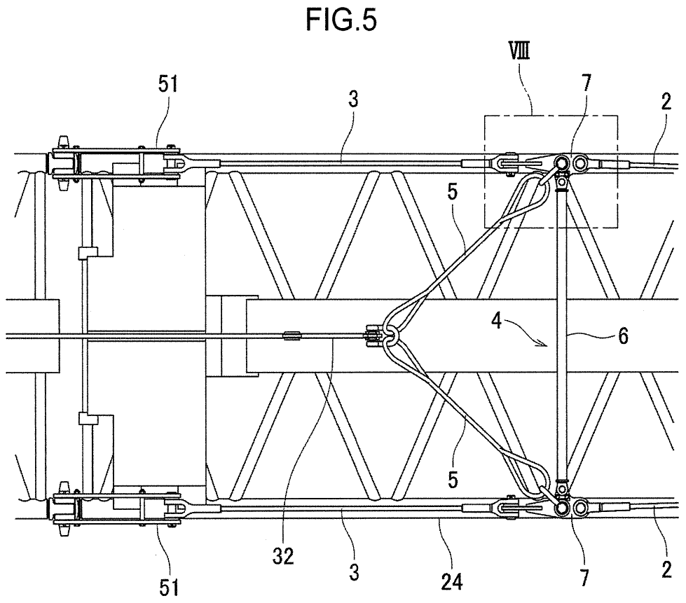

FIG. 5 is a plan view showing the intermediate member 4 and the periphery thereof, and the crane 1 further includes a pair of string-shaped members 5 shown in FIG. 5. Each of the string-shaped members 5 according to the present embodiment is a sling, but it may be either a rope or a wire. The pair of string-shaped members 5 are connected to the opposite end parts of the intermediate member 4, respectively. In the present embodiment, the pair of string-shaped members 5 have respective lengths equal to each other. Each of the string-shaped members 5 includes opposite end parts, one of which is an intermediate connection end part to be connected to one of the opposite end parts of the intermediate member 4 and the other is a rope connection end part to be connected to the rope tip part of the hoisting rope 32. There may be a further member to be interposed between the pair of string-shaped members 5 and the rope tip part of the hoisting rope 32. For example, the further member may be a string-shaped member such as a sling, including one end part to be connected to the rope connection end part of each of the pair of string-shaped members 5 and the other end part to be connected to the rope tip part of the hoisting rope 32.

The intermediate member 4 includes an intermediate member body 6, a pair of connection parts 7 and a pair of pins 9. The intermediate member body 6 extends in the boom width direction (vertical direction in FIG. 5), which is the width direction of the boom 24. The pair of connection parts 7 are joined to the opposite end parts 6d in the boom width direction of the intermediate member body 6 through the pair of pins 9, respectively. To each of the connection parts 7 are connected the first intermediate connection end part of the first guyline 2 and the second intermediate connection end part of the second guyline 3.

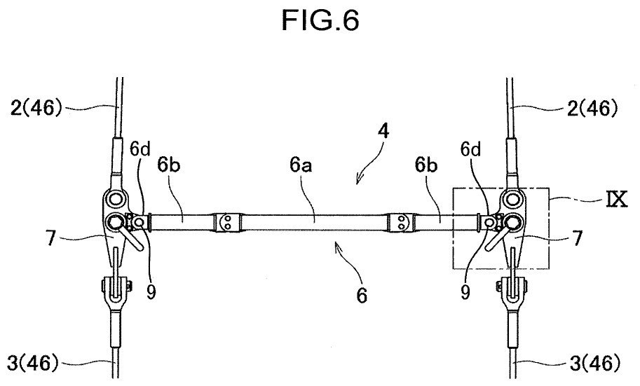

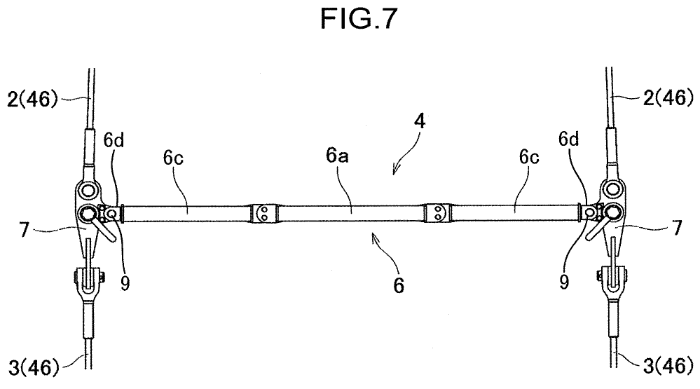

The intermediate member 4 preferably has a variable widthwise length. The widthwise length is the length of the intermediate member 4 in the boom width direction. FIGS. 6 and 7 show an example of the intermediate member 4 having such a variable widthwise length. FIG. 6 is a plan view showing a first length state of the intermediate member 4, and FIG. 7 is a plan view showing a second length state of the intermediate member 4. The second length state is a state where the widthwise length of the intermediate member 4 is larger than that in the first length state. Specifically, the intermediate member body 6 is composed of a base part 6a shown in FIGS. 6 and 7 and a pair of outer parts, and each of the outer parts is selected from among a plurality of candidate outer parts having different lengths from each other. In the example shown in FIGS. 6 and 7, the plurality of candidate outer parts include a first outer part 6b shown in FIG. 6 and a second outer part 6c shown in FIG. 7. The base part 6a is disposed at the center in the boom width direction, including opposite end parts in the boom width direction, to each of which end parts one of the plurality of candidate outer parts (one of the first outer part 6b and the second outer part 6c in the example) is alternatively and detachably connected. The base part 6a, thus, is a common member to be used in both of the first length state and the second length state, and the first and second outer parts 6b, 6c included in the plurality of candidate outer parts are exchangeable members that are exchangeably connected to the base part 6a to change the widthwise length of the intermediate member 4. Thus, the exchange between the first outer part 6b and the second outer part 6c enables the widthwise length of the intermediate member 4 to be changed. The plurality of candidate outer parts may include a further candidate outer part having a length different from either of the lengths of the first and second outer parts 6b, 6c.

The change of the widthwise length of the intermediate member 4 enables the intermediate member 4 to be applied in common to a plurality of types of booms 24 having different widths, that is, to have the widthwise length matched with the width of the boom 24. Preferably, the base part 6a is joined with the first outer part 6b or the second outer part 6c through a plurality (two in FIGS. 6 and 7) of pins. This restrains the first outer part 6b or the second outer part 6c from relative rotation to the base part 6a. Besides, the axial direction of the pair of pins 9 for joining the opposite end parts (the outer end parts of the first outer part 6b or the second outer part 6c) 6d of the intermediate member body 6 and the connection part 7 and the axial direction of the pin for joining the base part 6a and the first outer part 6b or the second outer part 6c, preferably, intersect each other.

The intermediate member body 6 may be configured to allow the width-direction length to be steplessly changed. For example, the intermediate member body 6 may include an outer cylinder and an inner cylinder to be fitted to cach other capably of mutually sliding in the boom width direction to allow the entire intermediate member body 6 to be expanded and contracted by relative movement of the inner cylinder to the outer cylinder in the boom width direction.

In the assembly of the crane 1, as shown in FIG. 2, the strut 27 and the jib 25 are attached to the boom 24 while being kept integrally coupled to each other with the strut 27 in a fallen posture in which the strut 27 has been fallen onto the jib back surface of the jib 25. On the other hand, through the pair of string-shaped members 5, the rope tip part of the hoisting rope 32 is connected to the intermediate member 4. Besides, to the opposite end parts of the intermediate member 4 (in the present embodiment, the pair of connection parts 7) are connected the second intermediate connection end parts of the pair of second guylines 3, respectively. In this state, the hoisting winch 43 performs the winding motion of winding the hoisting rope 32, thereby towing the strut 27 so as to move the rope tip part in a direction to approach the hoisting winch 43 to raise the strut 27 from the fallen posture.

By the winding motion are moved the intermediate member 4 connected to the rope tip part through the pair of string-shaped members 5 and the pair of second guylines 3 connected to the intermediate member 4 in a direction to approach the pair of guyline connection parts 51 shown in FIG. 3. In a state where the distance between the boom connection end part of the second guyline 3 thus approaching the pair of guyline connection parts 51 and the guyline connection part 51 has become equal to or less than a fixed distance, the boom connection end part of the second guyline 3 can be connected to the guyline connection part 51.

Thus, the movement of the intermediate member 4 in the direction in which the intermediate member 4 approaches the guyline connection part 51 reduces the distance between respective boom connection end parts of the pair of second guylines 3 connected to the intermediate member 4 and the pair of guyline connection parts 51 to allow the boom connection end parts to be easily connected to the pair of guyline connection parts 51. Besides, required for the connection to be handled is only the second guyline 3 which is the part from the intermediate member 4 to the guyline connection part 51 in each of the strut guyline sets 46, which allows the work for the connection to be easily performed as compared with a case of handling a single long strut guyline continuous from the strut 27 to the guyline connection part 51. This enables the workability to be improved about connecting the boom connection end part of the second guyline 3 in each of the strut guyline sets 46 to the guyline connection part 51 of the boom 24.

As shown in FIG. 5, the pair of string-shaped members 5, which have respective lengths equal to each other, can make the towing force by the hoisting rope 32 evenly act on the opposite end parts of the intermediate member 4 in the boom width direction, thereby allowing the intermediate member 4 to be towed toward the hoisting winch 43 shown in FIG. 2 with the restraint of the longitudinal direction of the intermediate member 4 from being inclined to the boom width direction. This allows the boom connection end parts of the pair of second guylines 3 to be easily aligned with the pair of guyline connection parts 51, respectively.

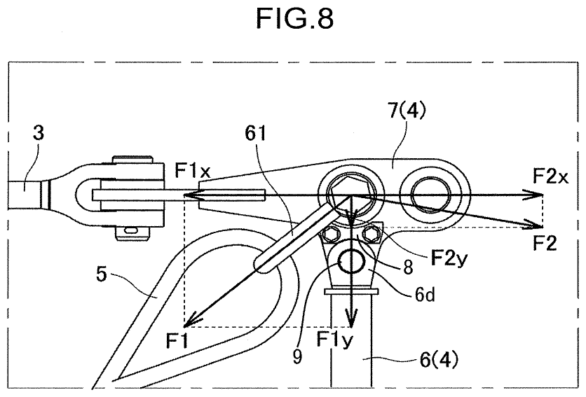

FIG. 8 is a view where the part enclosed by the enclosing line VII shown in FIG. 5 is enlarged; as shown in FIG. 8, the intermediate connection end parts of the pair of string-shaped members 5 are connected to the pair of connection parts 7 of the intermediate member 4, respectively, through respective connection metal fittings 61, each of which is composed of, for example, a shackle. The part to which the connection metal fitting 61 is to be connected in each of the connection parts 7 is preferably located on the extension of the center line of the intermediate member body 6, the center line extending in the longitudinal direction of the intermediate member body 6. This allows a first tension component F1x and a second tension component F2x shown in FIG. 8 to be balanced with each other. The first tension component F1x is the component of a tension F1 generated in each of the string-shaped members 5 by the towing force of the hoisting rope 32, being the component in a direction parallel to a boom longitudinal direction, which is the longitudinal direction of the boom 24; the second tension component F2x is the component of a tension F2 generated in the first guyline 2, being parallel to the boom longitudinal direction. The balance between the first and second tension components F1x and F2x restrains each of the connection parts 7 from relative rotation to the intermediate member body 6. Besides, both the component F1y, which is the component of the tension F1 in the direction parallel to the boom width direction and the component F2y, which is the component of the tension F2 in the direction parallel to the boom width direction, act as forces to press the pair of connection parts 7, respectively, against the intermediate member body 6 in the longitudinal direction of the intermediate member body 6; this allows the pair of connection parts 7 to be restrained from being displaced relatively to the intermediate member body 6 by the components F1y and F2y.

After the connection of the boom connection end part of the second guyline 3 to the guyline connection part 51 as shown in FIG. 5, the connection between the pair of string-shaped members 5 and the rope tip part of the hoisting rope 32 is released. Then, the pair of pins 9 that joins the intermediate member body 6 and the pair of connection parts 7, respectively, are pulled out, whereby the intermediate member body 6 is removed.

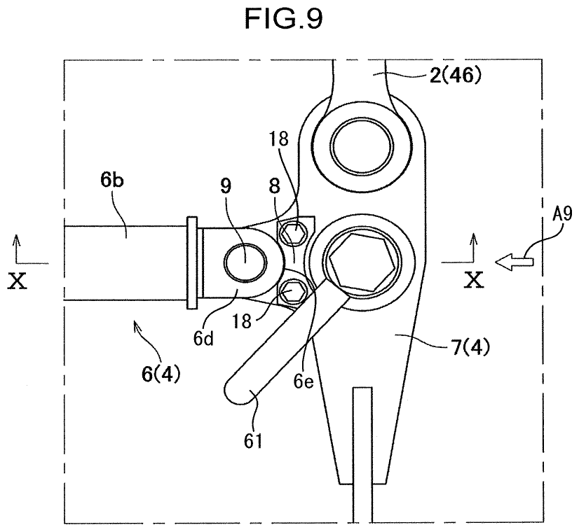

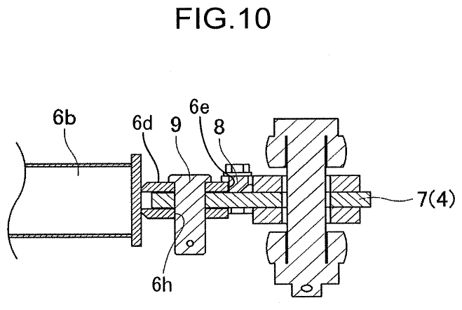

The intermediate member 4 further includes a pair of relative-displacement restraint parts 8 shown in FIGS. 6 to 10. The pair of relative-displacement restraint parts 8 are members that are displaced integrally with the pair of connection parts 7, respectively, while displaced independently of the pair of pins 9. The pair of relative-displacement restraint parts 8, in the example shown in FIGS. 8 to 10, are composed of members other than the components of the pair of connection parts 7, and fixed to the pair of connection parts 7 by a plurality of nuts 18, respectively. The pair of relative-displacement restraint parts 8, alternatively, may be formed integrally with the pair of connection parts 7, respectively. FIGS. 8 to 10 show only one of the pair of relative-displacement restraint parts 8 and one of the pair of pins 9. FIG. 9 is a view where the part enclosed by the enclosing line IX shown in FIG. 6 is enlarged, and FIG. 10 is a view showing a cross-section along the X-X line shown in FIG. 9.

The pair of pins 9 vertically penetrate the opposite end parts of the intermediate member body 6 and the pair of connection parts 7, respectively, with the opposite end parts of the intermediate member body 6 and the pair of connection parts 7 overlapping each other in a fallen-state vertical direction, respectively, thereby interconnecting the opposite end parts of the intermediate member body 6 and the pair of connection parts 7, respectively. The fallen-state vertical direction is a vertical direction in the boom-and-jib fallen state shown in FIGS. 2 and 3.

The pair of relative-displacement restraint parts 8, as shown in FIG. 9, abut against respective end surfaces 6e of the opposite end parts 6d of the intermediate member body 6 from both outer sides in the boom width direction, thereby restraining the relative-displacement restraint parts 8 and the pair of connection parts 7 from relative displacements to the intermediate member body 6 in the boom width direction, respectively, thereby allowing the pair of pins 9 to be easily inserted into and removal from the opposite end parts 6d and the pair of connection parts 7.

Specifically, when the interval between the boom connection end parts is smaller than the interval between the intermediate connection end parts of the pair of second guylines 3 with the connection of the pair of second guylines 3 to the pair of guyline connection parts 51, the tension of each of the second guylines 3 includes a component to displace the pair of connection parts 7 inward in the boom width direction, namely, a widthwise inward component, as indicated by arrow A9 in FIG. 9. Without restraint of the pair of connection parts 7 from relative displacement to the intermediate member body 6, the widthwise inward component would strongly press the pair of connection parts 7 inward in the boom width direction against the outer peripheral surface of the pair of pins 9 to thereby make the pair of pins 9 hard to pull out from the pair of connection parts 7. In contrast, the pair of relative-displacement restraint parts 8, restraining the pair of connection parts 7 from relative displacement to the intermediate member body 6 in the boom width direction, reduces the load that acts on the pair of pins 9 from the pair of connection parts 7 in the boom width direction, thereby allowing the pair of pins 9 to be suitably pulled out from the pair of connection parts 7 and the opposite end parts 6d of the intermediate member body 6, respectively.

More specifically, the opposite end parts 6d of the intermediate member body 6 are formed with respective pin holes 6h that allow the pair of pins 9 to be inserted thereinto, respectively, with a slight gap remaining between the inner peripheral surface of each of the opposite end parts 6d enclosing the pin hole 6h and the outer peripheral surface of the pin 9. The pair of relative-displacement restraint parts 8, which contact the end surfaces 6e of the opposite end parts 6d of the intermediate member body 6 from the outside in the boom width direction, keep the gaps between the inner peripheral surfaces enclosing the pin hole 6h and the outer peripheral surfaces of the pin 9 against the widthwise inward component of the tension of each of the second guylines 3, thereby allowing the pair of pins 9 to be easily pulled out from the pair of connection parts 7 and the opposite end parts 6d of the intermediate member body 6 regardless of the occurrence of the inward component in the width direction.

As shown in FIG. 4, each of the first guylines 2 includes a strut side part 2a and an intermediate-member side part 2b, which are interconnectable in series separably from each other. Specifically, the strut side part 2a includes a strut connection end part and a first interconnection end part on the side opposite thereto, and the intermediate-member side part 2b includes the first intermediate connection end part and a second interconnection end part to be separably connected to the first interconnection end part, the second interconnection end part being the end part on the side opposite to the first interconnection end part. The first guyline 2, therefore, is switchable between a first form in which the first interconnection end part of the strut side part 2a and the second interconnection end part of the intermediate-member side part 2b are interconnected and a second form in which the first and second interconnection ends are disconnected from each other to separate the strut side part 2a and the intermediate-member side part 2b from each other.

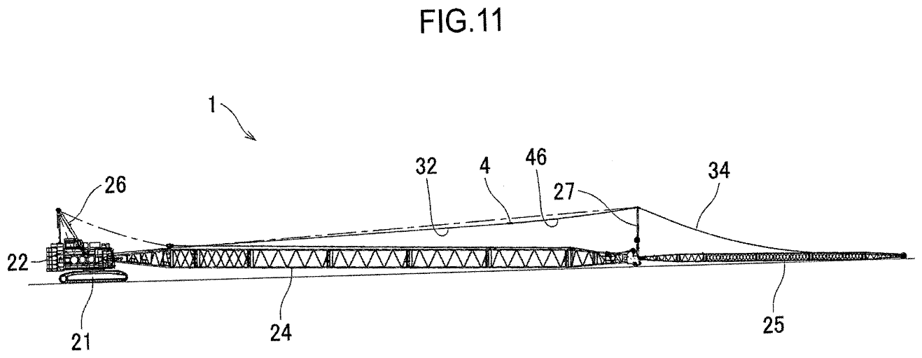

When the boom 24 is in a second boom state of having a greater total length, as shown in FIG. 11, which is a side view of the crane 1, than that in a first boom state shown in FIG. 2, the position of the intermediate member 4 when the hoisting rope 32 is wound by the hoisting winch 43 is higher than that in the first boom statc. In the state, mere suspension of the second guyline 3 from the intermediate member 4, if the first guyline 2 is left in the first form, may be not enough to allow the boom connection end part of the second guyline 3 to be sufficiently close to the guyline connection part 51.

In contrast, even when the boom 24 is long as shown in FIG. 11, switching the first guyline 2 to the second form and connecting the second intermediate connection end part of the second guyline 3 to the intermediate member 4 through the intermediate-member side part 2b while interconnecting the strut 27 and the intermediate member 4 through the strut side part 2a enables the intermediate-member side part 2b and the second guyline 3 to be suspended from the intermediate member 4 while being kept interconnected to allow the boom connection end part of the second guyline 3 to be sufficiently close to the guyline connection part 51. This allows the boom connection end part of the second guyline 3 to be suitably connected to the guyline connection part 51 in spite that the boom 24 is long.

Next will be described a method for assembling the crane 1 with reference to the drawings. The following description is made about the step for connecting the jib 25 to the boom 24 in the boom-and-jib fallen state and raising the boom 24 and the jib 25.

First, as shown in FIG. 2, to the boom 24 fallen on the ground is connected the lower jib 25a to which the strut 27 has been already connected. In this state, the intermediate jib 25b and the upper jib 25c are assembled sequentially in this order to the lower jib 25a.

Next, the rope tip part of the hoisting rope 32 is connected to the intermediate member 4 through the pair of string-shaped members 5. In this state, the hoisting winch 43 performs a winding motion of winding the hoisting rope 32, whereby the strut 27 makes rotational movement so as to be raised from the fallen posturc.

By the winding motion of winding the hoisting rope 32, the intermediate member 4 and the pair of second guylines 3 connected to the intermediate member 4 are moved to approach the pair of guyline connection parts 51. Coming into a state where respective distances between the boom connection end part of the pair of second guylines 3 and the pair of guyline connection parts 51 are equal to or less than a fixed value as shown in FIG. 3, the boom connection end parts of the second guylines 3 is connected to the pair of guyline connection parts 51.

Thus, the approach of the intermediate member 4 and the pair of second guylines 3 to the guyline connection part 51 in accompany with the winding motion reduces respective distances between the boom connection end parts of the pair of second guylines 3 and the pair of guyline connection parts 51 to allow the work of connecting the boom connection end part to the guyline connection part 51 to be easily performed. Besides, required to be handled for the connection in the strut guyline set 46 is only the second guyline 3 extending from the intermediate member 4 to the guyline connection part 51, which allows the connection work to be easily performed as compared with a case of handling a single and long strut guyline extending continuously from the strut 27 to the guyline connection part 51. This allows the workability to be improved about connecting the boom connection end parts of the pair of strut guyline sets 46 to the pair of guyline connection parts 51 of the boom 24.

After the arrival of the strut 27 at the raised posture shown in FIG. 2, the jib backstop device 47 comes to be received by the backstop receiver provided in the strut 27, and the strut backstop device 48 comes to be received by the backstop receiver provided in the boom 24.

Next, the connection between respective rope connection end parts of the string-shaped members 5 and the rope tip part of the hoisting rope 32 is released, and the intermediate member body 6 is removed from the intermediate member 4. In this state, the boom derricking winch 45 winds the boom derricking rope 41, thereby raising the boom 24 as shown in FIG. 1. If the boom 24 is in the long state as shown in FIG. 11 to locate the intermediate member 4 at a high position, may be omitted the step of removing the intermediate member body 6 from the intermediate member 4.

The embodiment described above is merely an example of a specific example, and in particular, the present invention is not limited, and a specific configuration or the like can be designed and changed as appropriate. The effects and effects described in the embodiments of the invention are merely listing most suitable actions and effects arising from the present invention, and the actions and effects of the invention are not limited to those described in the embodiments of the present invention.

As has been described, a crane and a crane assembly method are provided which enable the workability of connecting a guyline for interconnecting a strut and a boom to a predetermined position in the boom to be improved.

Provided is a crane comprising a crane body, a boom, a jib, a strut, a winch, a winch rope, an intermediate member, at least one first guyline, and at least one second guyline. The boom includes a boom proximal end part connected to the crane body so as to allow the boom to be raised and lowered with respect to the crane body, a boom distal end part on the side opposite to the boom proximal end part, and a guyline connection part. The jib includes a jib proximal end part connected to the boom distal end part so as to allow the jib to be raised and lowered with respect to the boom. The strut includes a strut proximal end part and a guyline connection part, and the strut proximal end part is connected to the boom distal end part or the jib proximal end part capably of vertically rotational movement so as to allow the strut to be raised and lowered with respect to the jib. The winch is fixed to the crane body or the boom, and performs a winding motion and a delivery motion. The winch rope is wound to the winch by the winding motion and delivered from the winch by the delivery motion. The winch rope includes a rope tip part that is moved, in a direction to approach the winch, by the winding motion. The intermediate member is connectable to the rope tip part so as to be moved by the winding motion together with the rope tip part. The at least one first guyline is disposed to interconnect the strut and the intermediate member, including a strut connection end part to be connected to the strut and a first intermediate connection end part, which is an end part on the side opposite to the strut connection end part, to be connected to the intermediate member. The at least one second guyline is disposed to interconnect the intermediate member and the boom, including a boom connection end part to be connected to the guyline connection part of the boom and a second intermediate connection end part, which is an end part on the side opposite to the boom connection end part, to be connected to the intermediate member. The at least one first guyline interconnects the strut and the intermediate member so as to allow the strut having been fallen onto the ground to be raised by the winch performing the winding motion of winding the winch rope with the rope tip part connected to the intermediate member in a boom-and-jib fallen state where the boom and the jib have been fallen onto the ground. The second intermediate connection end part of the at least one second guyline is connected to the intermediate member so as to allow the at least one second guyline to be made approach the guyline connection part together with the intermediate member by the winding motion of the winch to allow the boom connection end part of the second guyline to be connected to the guyline connection part.

According to the crane, the strut having been fallen can be raised by the winch that performs the winding motion in the boom-and-jib fallen state. In addition, the winding motion makes the intermediate member and the boom connection end part of the second guyline approach the guyline connection part with the second intermediate connection end part of the second guyline connected to the intermediate member to render the distance between the boom connection end part and the guyline connection part equal to or less than a fixed distance, thereby allowing the work of connecting the boom connection end part to the guyline connection part to be easily performed. Besides, required for the connection to be handled is only the second guyline extending from the intermediate member to the guyline connection part, which allows the work for the connection to be easily performed as compared with a case of handling a single long strut guyline extending from the strut to the guyline connection part. This allows the workability to be improved about connecting the guyline for interconnecting the strut and the guyline connection part of the boom to the guyline connection part.

Preferably, the at least one second guyline includes a pair of second guylines connectable to opposite end parts of the intermediate member in a boom width direction that is a width direction of the boom, and the at least one guyline connection part includes a pair of guyline connection parts corresponding to the pair of second guylines. The pair of second guylines can stably interconnect the intermediate member and the boom.

In this case, it is preferable that the crane further comprises a pair of string-shaped members having respective lengths equal to each other, the pair of string-shaped members including intermediate connection end parts to be connected to the opposite end parts of the intermediate member, respectively, and rope connection end parts, which are end parts on the side opposite to the intermediate connection end parts, to be connected to the rope tip part of the winch ropc. The pair of string-shaped members thus having respective lengths equal to each other enable the intermediate member to be towed by the winch that performs the winding motion with the restraint of the intermediate member from being inclined to the boom width direction, thereby allowing the boom connection end parts of the pair of second guylines to be easily aligned with the pair of guyline connection parts, respectively.

Preferably, the intermediate member has a variable length in the boom width direction. The change of the length enables the intermediate member in common to a plurality of types of booms having different widths to be applied.

Preferably, the intermediate member includes an intermediate member body extending in the boom width direction, a pair of connection parts connected to opposite end parts of the intermediate member body in the boom width direction, respectively, a pair of pins to penetrate both the pair of connection parts and the opposite end parts of the intermediate member body to interconnect the pair of connection parts and the opposite end parts of the intermediate member body, respectively, and a relative-displacement restraint part provided for at least one of the pair of connection parts; the at least one first guyline includes a pair of first guylines; the first intermediate connection end parts of the pair of first guylines and the second intermediate connection end parts of the pair of second guylines are connected to the pair of connection parts, respectively; the relative-displacement restraint part restrains a corresponding connection part that corresponds to the relative-displacement restraint part between the pair of connection parts from inward relative displacement in the boom width direction to the intermediate member body to thereby reduce an inward load in the boom width direction applied to the pin from the corresponding connection part. The relative-displacement restraint unit restrains the tensions of the pair of second guylines from displacing the corresponding connection part inward in the boom width direction relatively to the intermediate member body in the case where the interval between the boom connection end parts is smaller than the interval between the second intermediate connection end parts of the pair of second guylines, thereby reducing the load that acts on the pin from the corresponding connection unit inward in the boom width direction to allow the pin to be suitably pulled out from the corresponding connection unit and the intermediate member body.

Preferably, the at least one first guyline includes a strut side part and an intermediate-member side part, being switchable between a first form in which the strut side part and the intermediate-member side part are interconnected in series and a second form in which the strut side part and the intermediate-member side part are separated from each other; in the first form, the strut and the intermediate member are interconnected through the strut side part and the intermediate-member side part that are interconnected; in the second form, the strut and the intermediate member are interconnected through the strut side part and the second guyline is connected to the intermediate member through the intermediate-member side part. The at least one first guyline, when switched to the second form in the case where the boom is so long that the intermediate member is at a high position, can allow both the second guyline and the intermediate-member side part of the first guyline to be suspended from the intermediate member to enable the boom connection end part of the second guyline to be rendered close to the guyline connection part, thereby allowing the boom connection end part to be suitably connected to the guyline connection part regardless of the height position of the intermediate member.

Also provided is a method for assembling a crane. The crane includes a boom, a jib, a strut, a winch rope, an intermediate member, a first guyline, and a second guyline. The boom includes a boom proximal end part connected to the crane body so as to allow the boom to be raised and lowered with respect to the crane body, a boom distal end part on the side opposite to the boom proximal end part, and a guyline connection part. The jib includes a jib proximal end part connected to the boom distal end part so as to allow the jib to be raised and lowered with respect to the boom. The strut includes a strut proximal end part and a guyline connection part, and the strut proximal end part is connected to the boom distal end part or the jib proximal end part capably of vertically rotational movement so as to allow the strut to be raised and lowered with respect to the jib. The winch is fixed to the crane body or the boom, and performs a winding motion and a delivery motion. The winch rope is wound to the winch by the winding motion and delivered from the winch by the delivery motion. The winch rope includes a rope tip part that is moved, in a direction to approach the winch, by the winding motion. The intermediate member is connectable to the rope tip part so as to be moved by the winding motion together with the rope tip part. The first guyline is disposed to interconnect the strut and the intermediate member, including a strut connection end part to be connected to the strut and a first intermediate connection end part, which is an end part on the side opposite to the strut connection end part, to be connected to the intermediate member. The second guyline is disposed to interconnect the intermediate member and the boom, including a boom connection end part to be connected to the guyline connection part of the boom and a second intermediate connection end part, which is an end part on the side opposite to the boom connection end part, to be connected to the intermediate member. The method includes raising the strut having been fallen on the jib and making the winch perform the winding motion with the second intermediate connection end part of the second guyline connected to the intermediate member to thereby make the intermediate member and the second guyline approach the guyline connection part and connecting the boom connection end part of the second guyline to the guyline connection part.

1. A crane comprising:
a crane body;
a boom that includes a boom proximal end part, a boom distal end part on a side opposite to the boom proximal end part, and a guyline connection part, the boom proximal end part connected to the crane body so as to allow the boom to be raised and lowered with respect to the crane body;
a jib that includes a jib proximal end part, which is connected to the boom distal end part so as to allow the jib to be raised and lowered with respect to the boom;
a strut that includes a strut proximal end part and a guyline connection part, the strut proximal end part connected to the boom distal end part or the jib proximal end part capably of vertically rotational movement so as to allow the strut to be raised and lowered with respect to the jib;
a winch that is fixed to the crane body or the boom and performs a winding motion and a delivery motion;
a winch rope that is wound to the winch by the winding motion and delivered from the winch by the delivery motion, the winch rope including a rope tip part that is moved, in a direction to approach the winch, by the winding motion;
an intermediate member connectable to the rope tip part so as to be moved by the winding motion together with the rope tip part;
at least one first guyline that is disposed to interconnect the strut and the intermediate member and includes a strut connection end part to be connected to the strut and a first intermediate connection end part, which is an end part on a side opposite to the strut connection end part, to be connected to the intermediate member; and
at least one second guyline that is disposed to interconnect the intermediate member and the boom and includes a boom connection end part to be connected to the guyline connection part of the boom and a second intermediate connection end part, which is an end part on a side opposite to the boom connection end part, to be connected to the intermediate member, wherein
the at least one first guyline interconnects the strut and the intermediate member so as to allow the strut having been fallen onto the ground to be raised by the winch performing the winding motion of winding the winch rope with the rope tip part connected to the intermediate member in a boom-and-jib fallen state where the boom and the jib have been fallen onto the ground, and
the second intermediate connection end part of the at least one second guyline is connected to the intermediate member so as to allow the at least one second guyline to be made approach the guyline connection part together with the intermediate member by the winding motion of the winch to allow the boom connection end part of the second guyline to be connected to the guyline connection part.

2. The crane according to claim 1, wherein the at least one second guyline includes a pair of second guylines connectable to opposite end parts of the intermediate member in a boom width direction that is a width direction of the boom, and the at least one guyline connection part includes a pair of guyline connection parts corresponding to the pair of second guylines, respectively.

3. The crane according to claim 2, further comprising a pair of string-shaped members having respective lengths equal to each other, the pair of string-shaped members including respective intermediate connection end parts to be connected to the opposite end parts of the intermediate member, respectively, and respective rope connection end parts, which are end parts on a side opposite to the intermediate connection end parts, to be connected to the rope tip part of the winch rope.

4. The crane according to claim 2, wherein the intermediate member has a variable length in the boom width direction.

5. The crane according to claim 2, wherein: the intermediate member includes an intermediate member body extending in the boom width direction, a pair of connection parts connected to opposite end parts of the intermediate member body in the boom width direction, respectively, a pair of pins to penetrate both the pair of connection parts and the opposite end parts of the intermediate member body to interconnect the pair of connection parts and the opposite end parts of the intermediate member body, respectively, and a relative-displacement restraint part provided for at least one of the pair of connection parts; the at least one first guyline includes a pair of first guylines; the first intermediate connection end parts of the pair of first guylines and the second intermediate connection end parts of the pair of second guylines are connected to the pair of connection parts, respectively; the relative-displacement restraint part restrains a corresponding connection part that corresponds to the relative-displacement restraint part between the pair of connection parts from inward relative displacement in the boom width direction to the intermediate member body to thereby reduce an inward load in the boom width direction applied to the pin corresponding to the corresponding connection part between the pair of connection parts from the corresponding connection part.

6. The crane according to claim 1, wherein: the at least one first guyline includes a strut side part and an intermediate-member side part, being switchable between a first form in which the strut side part and the intermediate-member side part are interconnected in series and a second form in which the strut side part and the intermediate-member side part are separated from each other; in the first form, the strut and the intermediate member are interconnected through the strut side part and the intermediate-member side part that are interconnected; in the second form, the strut and the intermediate member are interconnected through the strut side part and the second guyline is connected to the intermediate member through the intermediate-member side part.

7. A method for assembling a crane that includes: a crane body; a boom that includes a boom proximal end part connected to the crane body so as to allow the boom to be raised and lowered with respect to the crane body, a boom distal end part on a side opposite to the boom proximal end part, and a guyline connection part; a jib that includes a jib proximal end part, which is connected to the boom distal end part so as to allow the jib to be raised and lowered with respect to the boom; a strut that includes a strut proximal end part and a guyline connection part, the strut proximal end part connected to the boom distal end part or the jib proximal end part capably of vertically rotational movement so as to allow the strut to be raised and lowered with respect to the jib; a winch that is fixed to the crane body or the boom and performs a winding motion and a delivery motion; a winch rope that is wound to the winch by the winding motion and delivered from the winch by the delivery motion, the winch rope including a rope tip part that is moved, in a direction to approach the winch, by the winding motion; an intermediate member connectable to the rope tip part so as to be moved by the winding motion together with the rope tip part; a first guyline that is disposed to interconnect the strut and the intermediate member and includes a strut connection end part to be connected to the strut and a first intermediate connection end part, which is an end part opposite to the strut connection end part, to be connected to the intermediate member; and a second guyline that is disposed to interconnect the intermediate member and the boom and includes a boom connection end part to be connected to the guyline connection part of the boom and a second intermediate connection end part, which is an end part on a side opposite to the boom connection end part, to be connected to the intermediate member, the method comprising:
connecting the rope tip part to the intermediate member and making the winch perform the winding motion in a boom-and-jib fallen state where the boom and jib have been fallen onto the ground to thereby raise the strut having been fallen on the jib; and
making the winch perform the winding motion in a state where the second intermediate connection end part of the second guyline is connected to the intermediate member to thereby make the intermediate member and the second guyline approach the guyline connection part and connecting the boom connection end part of the second guyline to the guyline connection part.
